(19) United States
(12) Patent Application Publication
(10) Pub. No.: US 2009/0085011 A1
(43) Pub. Date: Apr. 2, 2009

(54) NEUTRON SHIELDING COMPOSITION

(76) Inventors: Joseph D. Lichtenhan, Petal, MS (US); Paul Wheeler, Hattiesburg, MS (US); Xuan Fu, Purvis, MS (US)

Correspondence Address: PILLSBURY WINTHROP SHAW PITTMAN LLP, P.O. BOX 10500, MCLEAN, VA, 22102, US

(21) Appl. No.: 12/240,891

(22) Filed: Sep. 29, 2008

Related U.S. Application Data
(63) Continuation-in-part of application No. 11/015,185, filed on Dec. 17, 2004.
Application No. 11/015,185 is a continuation-in-part of application No. 11/342,240, filed on Jan. 27, 2006.
(60) Provisional application No. 60/976,294, filed on Sep. 28, 2007.
(60) Provisional application No. 60/531,458, filed on Dec. 18, 2003.
(60) Provisional application No. 60/648,327, filed on Jan. 27, 2005.

(51) Int. Cl. G21F 1/10; B29C 69/00

(52) U.S. Cl. 252/478; 264/241

(57) ABSTRACT

A composition for shielding living tissue from cosmic radiation exposure during air and space flights, using polyhedral oligomeric silsesquioxanes incorporating metals with high neutron capture cross-sections. Methods for incorporation of such compositions into textiles, garments, and skin lotions are described.

### CROSS-REFERENCE TO RELATED APPLICATIONS

This application claims the benefit of U.S. Provisional Patent Application Ser. No. 60/976,294 filed Sep. 28, 2007, and is (a) a continuation-in-part of U.S. patent application Ser. No. 11/015,185 filed Dec. 17, 2004, which claims the benefit of U.S. Provisional Patent Application Ser. No. 60/531,438 filed Dec. 18, 2003, and (b) a continuation-in-part of U.S. patent application Ser. No. 11/342,240 filed Jan. 27, 2006, which claims the benefit of U.S. Provisional Patent Application Ser. No. 60/648,327 filed Jan. 27, 2005.

### FIELD OF THE INVENTION

This invention relates generally to methods for shielding cockpit and cabin crew, passengers, and cargo from exposure to cosmic radiation during air and space travel using materials that include polyhedral oligomeric silsesquioxanes incorporating metals with high neutron capture cross-sections. The invention can also be utilized for shielding humans, animals, livestock, tissue, and other living organisms from cosmic radiation.

### BACKGROUND

The invention is related to use of polyhedral oligomeric silsesquioxane, silsesquioxane, polyhedral oligomeric silicate, silicates, and silicones or metallized-polyhedral oligomeric silsesquioxane, silsesquioxane, polyhedral oligomeric silicate, silicates, and silicones as alloyable agents in combination with metallic powders, polymeric materials and textiles. The polyhedral oligomeric silsesquioxane, silsesquioxane, polyhedral oligomeric silicate, silicates, and silicones or metallized-polyhedral oligomeric silsesquioxane, silsesquioxane, polyhedral oligomeric silicate, silicates, and silicones are hereafter referred to as “silicon containing agents”.

Silicon containing agents have previously been utilized to complex metal atoms. Such silicon containing agents are useful for the dispersion and alloying of silicon and metal atoms with polymer chains uniformly at the nanoscopic level. Silicon containing agents with metal atoms dispersed within a polymeric carrier have utility for the shielding of sensitive electronic components from the damaging effects of ionizing radiation.

Cosmic radiation is a form of ionizing radiation that mainly consists of primary particles (i.e., protons, electrons, and heavier ions) and secondary particles (e.g. neutrons) formed when these particles reach the Earth's atmosphere. At sea level cosmic radiation contributes about 13% to the natural background radiation.

Cosmic radiation is different from other forms of ionizing radiation. For example, nuclear industry workers or medical personnel are mostly exposed to gamma-radiation and X-rays. Shielding against X-ray and gamma radiation is accomplished by use of dense material such as lead. In contrast, neutrons are not effectively shielded by dense metals. Neutron shielding is accomplished through capture by an atom with a large cross-sectional area for neutrons of specific energy (e.g. Gd, ¹⁰B, Sm, Cd). Neutrons are subatomic particles which when compared to X-rays or gamma rays cause more biological damage per dose unit. The biological effects of neutrons and cosmic radiation in general are not fully understood but all forms of ionizing radiation are known to pose health risk.

As a rule, cosmic radiation levels rise with increasing altitude (up to about 20 km above ground). The actual radiation level is influenced by a number of factors, most importantly through the shielding provided by the earth's atmosphere. The overall effect for flight crew and travelers is an increased radiation exposure during flights as compared to staying on the ground.

The level of cosmic radiation in the Earth's atmosphere depends primarily on four factors, listed below in order of their importance in contributing to radiation levels:

1. Altitude. The Earth's atmospheric layer provides significant shielding from cosmic radiation. At higher altitudes, this shielding effect decreases, leading to higher levels of cosmic radiation. The radiation exposure at conventional aircraft flight altitudes of 30,000-40,000 feet (9-12 km) is about 100 times higher than on the ground.

2. Geographic Latitude. The Earth's magnetic field deflects many cosmic radiation particles that would otherwise reach ground level. This shielding is most effective at the equator and decreases at higher latitudes, essentially disappearing at the poles. As a result, there is approximately a doubling of cosmic radiation exposure from the equator to the magnetic poles.

3. Normal Solar Activity. The sun's activity varies in a predictable way with a cycle of approximately 11 years. Higher solar activity leads to lower cosmic radiation levels and vice versa.

4. Solar Proton Events (SPEs) (also sometimes called “solar particle events” or “solar events”). Occasionally large explosive ejections of charged particles occur on the sun. They can lead to sudden increases in radiation levels in the atmosphere and on Earth, the solar proton events. SPEs are not predictable, and levels of radiation caused by an SPE are not uniform over the Earth. Large SPEs in which significant levels of cosmic radiation reach Earth are rare events.

Prior art for shielding of living tissue from ionizing radiation has varied depending on the type of radiation and the specific conditions for environmental exposure. For example, numerous companies have developed sunscreens, eyeglasses and clothing to protect against UV radiation. Numerous aprons, caps, gloves, garments, etc., have developed for shielding against X-rays. Similarly a wide array of products exist for shielding against non-ionizing electrical magnetic force radiation. This prior art is deficient, however, in protecting against neutron radiation. According to the World Health Organization, epithermal and thermal neutron radiation accounts for 50% of the effective radiation dose that air crew and air travelers receive during high altitude flights.

The increased use of polymer composites in aircraft along with transpolar flights further increase the likelihood of exposure to cosmic radiation, since the metal used in fuselages and a thick atmosphere are no longer present to afford traditional levels of shielding. Therefore, a need exists to reduce the exposure of flight crew, pilots, passengers and live cargo to cosmic radiation exposure during flight. Of particular concern is reducing the exposure level of fetuses and pregnant women to cosmic radiation.

### SUMMARY OF THE INVENTION

We have discovered that shield materials including silicon containing agents incorporating a metal having a high neutron capture cross-section, dispersed with a polymeric carrier, are useful in combination with textiles for shielding human tissue against cosmic radiation. Such shield materials in the form of a lotion or cream are also useful for shielding of facial areas, hair, and hands, which are not conveniently protected by clothing from cosmic radiation exposure. In each capacity the silicon containing agents contained within the shield material are effective as compatibilizers and carriers of metal atoms. The silicon containing agents also provide trapping sites for ionization products resulting from radiation damage. For example, gadolinium oxide and gadolinium incorporated into silicon containing agents provide shielding against neutron, gamma, and X-ray radiation. A polymeric or oligomeric carrier allows for molding of the shield material into articles and for application to skin. Secondary functions of the polymeric carrier are to absorb heat and to provide shielding through hydrogen atom content.

Cost-effective and highly deployable shield materials have been developed that include silicon containing agents and metals with a high neutron capture cross-section. These shield materials are incorporated into protective garments and into creams or lotions for use by air passengers and live cargo. The simplest form of the solution involves the placement of premolded plaques with shield materials inside of pockets or cavities within a garment. Additionally, coating an article with such materials or weaving cloth from a fiber of such materials and subsequently manufacturing a garment will provide the needed protection. Also, the shield material can be incorporated into a topical sunscreen-like lotion or cream for protection of areas that cannot be covered by clothing.

### BRIEF DESCRIPTION OF THE DRAWINGS

FIG. 1 shows representative structural examples of nonmetallized silicon containing agents.

FIG. 2 shows representative structural examples of metallized silicon containing agents.

### Definition of Formula Representations for Nanostructures

For the purposes of understanding this invention's chemical compositions the following definitions for formula representations of silicon containing agents and in particular Polyhedral Oligomeric Silsesquioxane (POSS) and Polyhedral Oligomeric Silicate (POS) nanostructures are made.

Polysilsesquioxanes are materials represented by the formula [RSiO_{1.5}]_{∞} where ∞ represents molar degree of polymerization and R=represents organic substituent (H, siloxy, cyclic or linear aliphatic or aromatic groups that may additionally contain reactive functionalities such as alcohols, esters, amines, ketones, olefins, ethers or which may contain halogens). Polysilsesquioxanes may be either homoleptic or heteroleptic. Homoleptic systems contain only one type of R group while heteroleptic systems contain more than one type of R group.

A subset of silicon containing agents are classified as POSS and POS nanostructure compositions are represented by the formula:

[(RSiO_{1.5})ₙ]_{Σ#} for homoleptic compositions

[(RSiO_{1.5})ₙ(R′SiO_{1.5})ₘ]_{Σ#} for heteroleptic compositions (where R≠R′)

[(RSiO_{1.5})ₙ(RSiO_{1.0})ₘ(M)ⱼ]_{Σ#} for heterofunctionalized heteroleptic compositions

[(RSiO_{1.5})ₙ(RXSiO_{1.0})ₘ]_{Σ#} for functionalized heteroleptic compositions (where R groups can be equivalent or inequivalent)

In all of the above, R is the same as defined above and X includes but is not limited to siloxide, OH (silanol), Cl, Br, I, alkoxide (OR), acetate (OOCR), peroxide (OOR), amine (NR₂), isocyanate (NCO), and R. The symbol M refers to metallic elements within the composition that include high and low Z metals and in particular Al, B, Ga, Gd, Ce, W, Ni, Eu, Y, Zn, Mn, Os, Ir, Ta, Cd, Cu, Ag, V, As, Tb, In, Ba, Ti, Sm, Sr, Pb, Lu, Cs, Tl, Te. The symbols m, n and j refer to the stoichiometry of the composition. The symbol Σ indicates that the composition forms a nanostructure and the symbol # refers to the number of silicon atoms contained within the nanostructure. The value for # is usually the sum of m+n, where n ranges typically from 1 to 24 and m ranges typically from 1 to 12. It should be noted that Σ# is not to be confused as a multiplier for determining stoichiometry, as it merely describes the overall nanostructural characteristics of the system (aka cage size).

### DETAILED DESCRIPTION

The present invention teaches the use of silicon containing agents in combination with metal atoms or metal powders and a polymeric or oligomeric carrier for the shielding of living tissue from cosmic radiation during air or space flight. The invention provides methods of incorporating neutron shielding materials into textiles, garments and lotions. All of these methods provide some shielding against cosmic radiation. Determination as to the shielding thickness required to provided complete protection to living tissue is dependent upon knowledge of the radiation type, flux, energy level, modeling of the exposure environment. Despite these uncertainties, beneficial shielding is afforded by the present products toward reducing the overall exposure risk.

The keys that enable silicon containing agents such as nanostructured chemicals to function in this invention include: (1) their unique size with respect to polymer chain dimensions, and (2) their ability to be compatibilize and uniformly disperse metal atoms and metal particles with polymer and oil-based emulsions and thereby increase the homogeneity and loading level of a metal containing nanoscopic cage within a resulting polymeric composition or lotion.

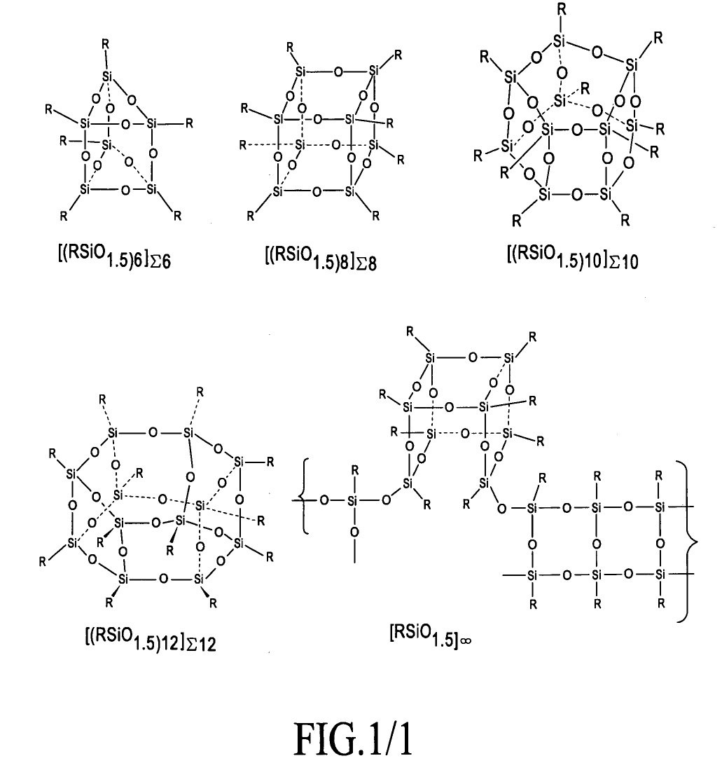

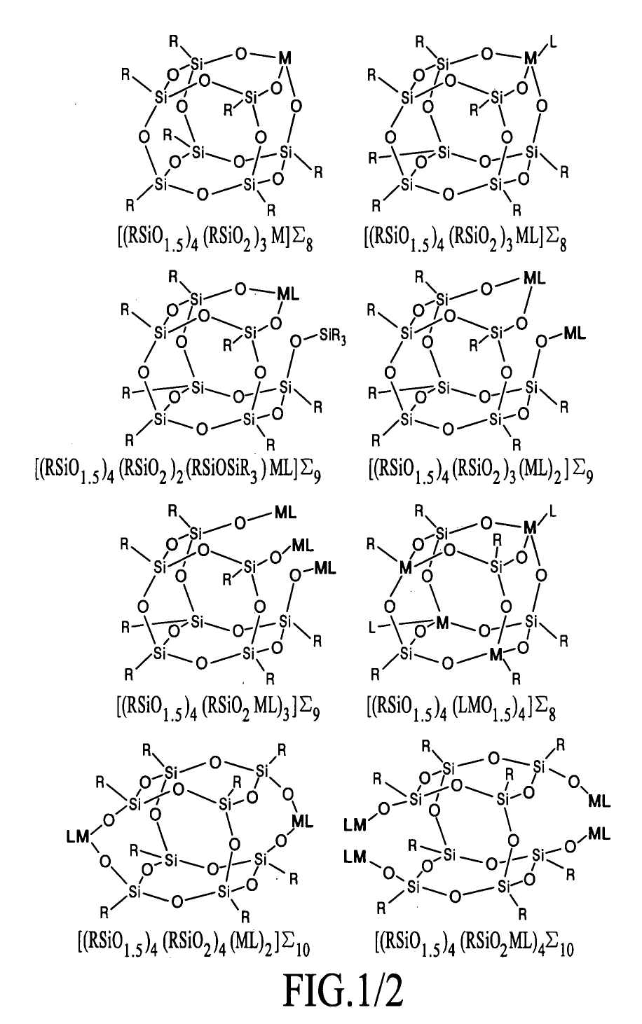

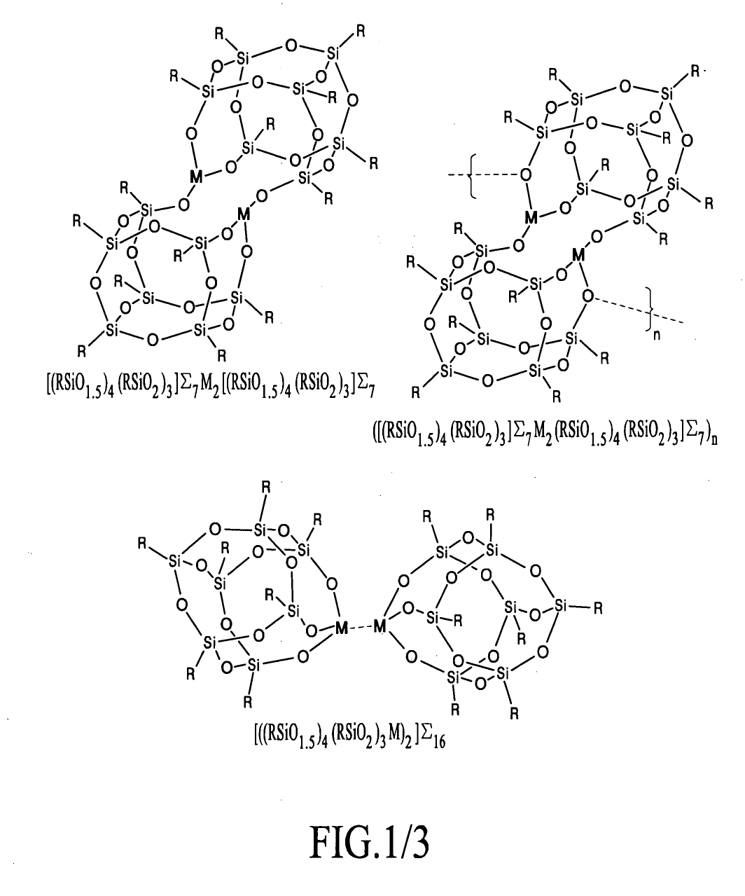

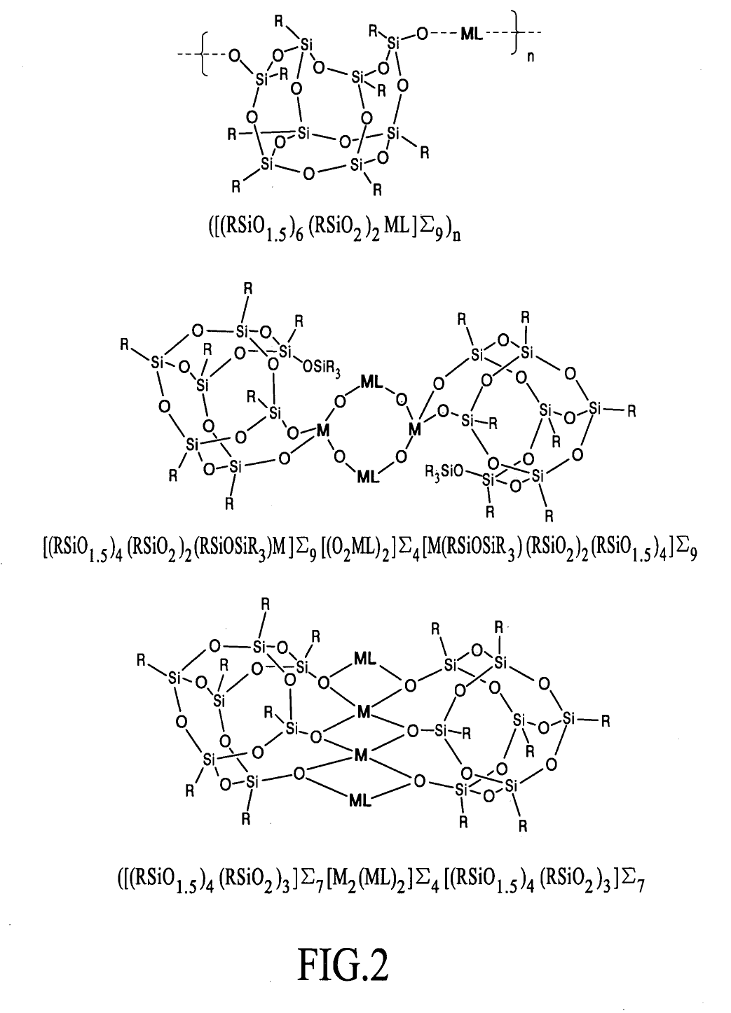

The silicon containing agents of most utility in this work are best exemplified by those based on low cost silicones, silsesquioxanes, polyhedral oligomeric silsesquioxanes, and polyhedral oligomeric silicates. FIG. 1 illustrates some representative examples of silicon containing siloxane, silsesquioxane, and silicate examples. FIG. 2 illustrates some representative examples of metallized versions of silsesquioxanes, polyhedral oligomeric silsesquioxanes, and polyhedral oligomeric silicates. The R groups in such structures can range from H, to alkane, alkene, alkyne, aromatic and substituted organic systems including ethers, acids, amines, thiols, phosphates, and halogenated R groups including fluorinated groups. The R groups on the exterior of the silicon containing agent ensure compatibility and tailorability of the nanostructure with organic polymers, creams, and lotions. These nanostructured chemicals are of low density, and can range in diameter from 0.5 nm to 5.0 nm.

The metal atoms and particles of preferred utility for shielding against radiation include all inorganic and organometallic derivatives of gadolinium, samarium, and boron for shielding against neutrons, and all inorganic and organometallic derivatives of tungsten, molybdenum, niobium, tantalum, samarium and gadolinium for shielding against X-rays. Other metals with a high atomic number such as lead and cadmium may also be utilized. Gadolinium has the highest cross sectional area for thermal neutrons and provides an economical cost advantage by not requiring isotopic enrichment. However, isotopic enrichment of gadolinium, samarium and boron will improve the effectiveness of neutron capture shielding.

Polymeric and oligomeric molecules into which dispersion of the silicon containing agents and metal particles are desired include aromatic, aliphatic, saturated and unsaturated hydrocarbons, alcohols, esters, ethers, acids, carbonates, amines, amides, imides, nitriles, ureas, urethanes, silicones, and thiols; rubbers; amorphous, crystalline, and semicrystalline polymers; and fluids for use as thermoset or thermoplastic resins.

Creams and lotions into which dispersion of the silicon containing agents and particles can be made include emulsions of oil-in-water and water-in-oil. The oily component can include mineral oil, petroleum jelly, proteins, lanolin, lanolin alcohol, xanthan gum, dimethicone, and parabens. The water component can contain antifloculants such as stearates, ammonium alcohols, glycols, ethers, alcohols, sorbitol, and ethylene ditetraamine.

The preferred compositions contain a physical mixture of metallized and nonmetallized silicon containing agents, with metallic and ceramic powders and a polymer or oligomeric material of manmade or natural origin. Preferably, the method of preparing the compositions involves mixing of the metallized or nonmetallized silicon containing agents into the polymer along with a metal powder and rendering of the material as thermoplastic pellets for molding of plaques or fiber spinning. Alternately the resulting formulation may be utilized as a coating, paint, adhesive, cosmetic, topical cream or oil. All types and techniques of blending, including melt blending, dry blending, solution blending, milling, reactive and nonreactive blending are effective. Alternately, the silicon containing agent can be coated on the particles prior to incorporation into a polymer or oligomer.

For creams and lotions, the preferred compositions contain a physical mixture of metallized and nonmetallized silicon containing agents, with metallic and ceramic powders and an oil-in-water or water-in-oil material of manmade or natural origin. The resulting material has utility for direct application to the skin or hair.

Silicon containing agents, such as the polyhedral oligomeric silsesquioxanes illustrated in FIG. 1, and metallized polyhedral oligomeric silsesquioxanes in FIG. 2, are available as solids and oils. Both forms dissolve in molten polymers or in solvents, or in lotions, and can be reactively on nonreactively incorporated. The dispersion of silicon containing agents appears to be thermodynamically governed by the free energy of mixing equation (ΔG=ΔH−TΔS). The nature of the R group and ability of the reactive groups on the cage to react or interact with polymers and surfaces greatly contributes to a favorable enthalpic (ΔH) term while the entropic term (ΔS) is highly favorable because of the monoscopic cage size and distribution of 1.0. Further, the nanoscopic cage provides a surface area of approximately 3200 m²/g and thereby controls interfacial interactions within the resulting material.

Loading levels of the silicon containing agents can range from 1-99% with a preferred range from 1-50 wt %, while metal particle loadings can range from 1-75 wt %, with a preferred loading range from 5-50 wt % with the remainder of the composition being composed of polymer or emulsion. Isotopically enriched gadolinium, boron, or samarium in the formulations can effectively reduce the loading level requirements for metallized silicon containing agents and metal. In addition, a more effective shielding composition will result from isotopically enriched elements, but cost of the final articles will also be significantly increased with such enriched elements.

### EXAMPLES

### General Process Variables Applicable to All Processes

As is typical with chemical processes there are a number of variables that can be used to control the purity, selectivity, rate and mechanism of any process. Variables influencing the process for the incorporation of silicon containing agents (e.g. silicones and silsesquioxanes) into plastics include the size and polydispersity, and composition of the nanoscopic agent. Similarly, the molecular weight, polydispersity and composition of the polymer system must also be matched between that of the silicon containing agent and polymer. Finally, the kinetics, thermodynamics, processing aids, and fillers, and type of metal powders used during the compounding or mixing process are also tools of the trade that can impact the loading level and degree of enhancement resulting from incorporation. Blending processes such as melt blending, dry blending and solution mixing blending are all effective at mixing and alloying nanoscopic silicon containing agents into plastics.

Alternate Method: Solvent Assisted Formulation. Silicon containing agents can be added to a vessel containing the desired polymer, prepolymer or monomers and dissolved in a sufficient amount of an organic solvent (e.g. hexane, toluene, dichloromethane, etc.) or fluorinated solvent to effect the formation of one homogeneous phase. The mixture is then stirred under high shear at sufficient temperature to ensure adequate mixing for 30 minutes and the volatile solvent is then removed and recovered under vacuum or using a similar type of process including distillation. Note that supercritical fluids such as CO₂ can also be utilized as a replacement for flammable hydrocarbon solvents. The resulting formulation may then be used directly or for subsequent processing.

The examples provided below should not be construed as limiting in design or method, or in specific material process combinations, compositions, or conditions.

### Example 1

### Polymeric Form of Shield Material

Using a twin screw extruder, a silicon containing agent [(iBuSiO_{1.5})₄(iBu(HO)SiO)₃]_{Σ7}, a metallized silicon containing agent [(iBuSiO_{1.5})₄(iBuSiO₂)₃Gd]_{Σ8}, a thermoplastic (EVA=ethylene vinyl acetate) EVA/polyamide (nylon) blend, and gadolinium oxide powder were added using weight loss feeders. The mixture was melt-mixed and a uniform white strand was extruded and pelletized. The pellets were subsequently injection molded into white flat plaques and glue sticks for incorporation into garments.

Alternately, a suitable formulation can also be achieved using a twin screw extruder, a thermoplastic polymer or polymer blend, and gadolinium oxide powder.

### Example 2

### Incorporation of Shield Material into Garments

The shield material extruder strand and pellets are suitable for spinning into a fiber for subsequent use in manufacturing woven cloth and garments. Alternately, the white thermoplastic pellets can be applied to garments or woven fabric as a coating via a hot-melt glue gun. Each of these methods is limited in assuring uniform thickness of shield material within a garment.

A preferred method of providing uniform shielding is to mold plaques of shield material with a precise and uniform thickness. These plaques can then be inserted into pockets within a vest, bib, apron, vest etc. Additional advantages of using plaques in this manner are that it allows for their removal prior to washing of the garment, and it allows for compact folding of the garment for storage and travel. Further the garment can be comfortably positioned while sitting or standing.

### Example 3

### Shield Material as a Protective Lotion

Using a paddle mixer, a silicon containing agent [(iBuSiO_{1.5})₄(iBu(HO)SiO)₃]_{Σ7}, a metallized silicon containing agent [(iBuSiO_{1.5})₄(iBuSiO₂)₃Gd]_{Σ8}, a commercial moisturizing lotion (Equate®), and gadolinium oxide powder were added and mixed until homogeneous. The white lotion was suitable for direct application to unbroken skin.

A preferred composition with optical transparency was obtained using a metallized silicon containing agent [(iBuSiO_{1.5})₄(iBuSiO₂)₃Gd]_{Σ8} and a commercial moisturizing lotion (Equate®). The resulting white colored lotion was ideal for skin coverage as it formed a smooth transparent layer and dried with a non-greasy, smooth feel.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A composition for shielding tissue from neutron radiation comprising:
(a) a metallized or non-metallized silicon containing agent selected from the group consisting of polyhedral oligomeric silsesquioxanes (POSS), silsesquioxanes, polyhedral oligomeric silicates (POS), silicates, and silicones;
(b) a metal selected from the group consisting of gadolinium, samarium, and boron, wherein the metal may be included in an inorganic or organometallic compound, including a metallized silicon containing agent; and
(c) a carrier selected from the group consisting of (i) aromatic, aliphatic, saturated and unsaturated hydrocarbons, alcohols, esters, ethers, acids, carbonates, amines, amides, imides, nitrites, ureas, urethanes, silicones, and thiols, (ii) rubbers, (iii) amorphous, crystalline and semi-crystalline polymers; (iv) liquid thermoset and thermoplastic resins; (v) mineral oil, petroleum jelly, proteins, lanolin, lanolin alcohol, xanthim gum, dimethicone, and parabens; and (vi) oil and water emulsions.

2. The composition of claim 1, wherein the metal is in a powder.

3. The composition of claim 2, wherein the silicon containing agent is metallized with a metal selected from the group consisting of gadolinium, samarium, and boron.

4. The composition of claim 1, wherein the silicon containing agent is selected from the group consisting of metallized or non-metallized POSS and POS.

5. The composition of claim 4, wherein the metal is in a powder.

6. The composition of claim 5, wherein the silicon containing agent is metallized with a metal selected from the group consisting of gadolinium, samarium, and boron.

7. The composition of claim 3, wherein the carrier is a polymer.

8. The composition of claim 6, wherein the carrier is a polymer.

9. The composition of claim 3, wherein the carrier is an oil and water emulsion.

10. The composition of claim 6, wherein the carrier is an oil and water emulsion.

11. A method for forming a neutron shielding material for tissue comprising the steps of:
(a) forming a mixture including (i) a metallized or non-metallized silicon containing agent selected from the group consisting of polyhedral oligomeric silsesquioxanes (POSS), silsesquioxanes, polyhedral oligomeric silicates (POS), silicates, and silicones; (ii) a metal selected from the group consisting of gadolinium, samarium, and boron, wherein the metal may be included in an inorganic or organometallic compound, including a metallized silicon containing agent; and (iii) a carrier selected from the group consisting of (A) aromatic, aliphatic, saturated and unsaturated hydrocarbons, alcohols, esters, ethers, acids, carbonates, amines, amides, imides, nitrites, ureas, urethanes, silicones, and thiols, (B) rubbers, (C) amorphous, crystalline and semi-crystalline polymers; (D) liquid thermoset and thermoplastic resins; and (E) mineral oil, petroleum jelly, proteins, lanolin, lanolin alcohol, xanthim gum, dimethicone, and parabens.
(b) rendering the mixture into thermoplastic pellets; and
(c) forming the pellets into a neutron shielding material.

12. The method of claim 11, wherein the metal is a powder.

13. The method of claim 12, wherein the silicon containing agent is metallized with a metal selected from the group consisting of gadolinium, samarium, and boron.

14. The composition of claim 11, wherein the silicon containing agent is selected from the group consisting of metallized or non-metallized POSS and POS.

15. The composition of claim 14, wherein the metal is in a powder.

16. The composition of claim 15, wherein the silicon containing agent is metallized with a metal selected from the group consisting of gadolinium, samarium, and boron.

17. A method for forming a neutron shielding emulsion for application to tissue comprising the steps of:
(a) forming a mixture including (i) a metallized or non-metallized silicon containing agent selected from the group consisting of polyhedral oligomeric silsesquioxanes (POSS), silsesquioxanes, polyhedral oligomeric silicates (POS), silicates, and silicones; (ii) a metal selected from the group consisting of gadolinium, samarium, and boron, wherein the metal may be included in an inorganic or organometallic compound, including a metallized silicon containing agent; and (iii) a carrier selected from the group consisting of mineral oil, petroleum jelly, proteins, lanolin, lanolin alcohol, xanthim gum, dimethicone, and parabens; and
(b) blending the mixture with water into an emulsion.

18. The method of claim 17, wherein the metal is a powder.

19. The method of claim 18, wherein silicon containing agent is metallized with a metal selected from the group consisting of gadolinium, samarium, and boron.

20. The composition of claim 17, wherein the silicon containing agent is selected from the group consisting of metallized or non-metallized POSS and POS.

21. The composition of claim 20, wherein the metal is in a powder.

22. The composition of claim 21, wherein the silicon containing agent is metallized with a metal selected from the group consisting of gadolinium, samarium, and boron.
